(19) United States
(12) Patent Application Publication
(10) Pub. No.: US 2025/0334773 A1
(43) Pub. Date: Oct. 30, 2025

(54) LIQUID MIRROR

(71) Applicant: Honeywell International Inc., Charlotte, NC (US)

(72) Inventors: Karl Roenigk, Ellicott City, MD (US); Amanda Childers, Arlington Heights, IL (US); Rebecca Kamire, Buffalo Grove, IL (US)

(21) Appl. No.: 18/646,258

(22) Filed: Apr. 25, 2024

(51) Int. Cl. G02B 7/185; G02B 5/08; G02B 5/10; G02B 7/18; G02B 7/183; G02B 23/06; G02B 26/00; G02B 26/08

(52) U.S. Cl. CPC G02B 7/185; G02B 5/0841; G02B 5/10; G02B 7/1815; G02B 7/183; G02B 23/06; G02B 26/004; G02B 26/0825

(57) ABSTRACT

An example liquid mirror includes a first liquid, a second liquid immiscible with the first liquid and configured to define an interface between the first liquid and the second liquid, and a plurality of reflective particles configured to self-assemble at the interface between the first liquid and the second liquid. The liquid mirror also includes a support structure defining an outer surface configured to support the first liquid and the second liquid. The outer surface, the first liquid, and the second liquid are configured to cause the plurality of reflective particles to form a focusing shape via capillary action of the first liquid and the second liquid and interaction with the support structure.

### TECHNICAL FIELD

The present disclosure relates to mirrors and techniques for making and using mirrors.

### BACKGROUND

Mirrors for telescopes in space are typically made using solid materials which can be polished such as glass, metal or ceramic and coated with reflective thin films. This approach becomes increasingly expensive with increasing mirror diameter, and increasingly susceptible to damage (e.g., by contact with debris) with increasing mirror diameter.

### SUMMARY

In general, the disclosure describes a liquid mirror and methods of making and/or using liquid mirrors. In some examples, a liquid mirror includes a first liquid configured to be immiscible with a second liquid and a plurality of reflective particles (e.g., nanoparticles configured to reflect electromagnetic radiation such as ultraviolet, visible, or infrared light, or any suitable wavelength electromagnetic radiation) disposed between the first and second ionic liquids, e.g., at an interface between the first and second liquids. In some examples, the liquid mirror includes a support structure configured to house and/or retain the first and second liquids and the reflective particles. The support structure may include an outer surface configured to, in conjunction with the first and second liquids, cause the interface and plurality of reflective particles to form a focusing shape, e.g., via capillary action of the first and second liquids. In some examples, the first and second liquids are ionic liquids.

In some examples, the liquid mirror includes a temperature controller configured to heat and/or cool a portion of the surface area of the outer surface of the support structure, e.g., to cause and/or change the capillary action. For example, a plurality of temperature controllers may be distributed on or within the support structure to control the temperature of a plurality of portions of the surface area of the outer surface of the support structure and control the capillary action, thereby controlling flow of the first and second liquids to form a focusing shape at the interface of the first and second liquids (and the reflective particles at the interface). The plurality of temperature controllers may be configured to cool the portions of the surface area to reduce the capillary action and flow of the first and second liquids, and in some examples to solidify and/or freeze the first and/or second liquid to retain and/or maintain the focusing shape of the interface.

In one example, this disclosure describes a liquid mirror including: a first liquid; a second liquid immiscible with the first liquid and configured to define an interface between the first liquid and the second liquid; a plurality of reflective particles configured to self-assemble at the interface between the first liquid and the second liquid; and a support structure defining an outer surface configured to support the first liquid and the second liquid, wherein the outer surface, the first liquid, and the second liquid are configured to cause the plurality of reflective particles to form a focusing shape via capillary action of the first liquid and the second liquid and interaction with the support structure.

In another example, this disclosure describes a method of forming a liquid mirror, the method including: dispensing a first liquid and a second liquid across an outer surface defined by a support structure, wherein the second liquid is immiscible with the first liquid and is configured to define an interface between the first liquid and the second liquid, wherein at least one of the first liquid or the second liquid comprises a plurality of reflective particles configured to self-assemble at the interface between the first liquid and the second liquid; and forming, via capillary action, the interface into a focusing shape.

In another example, this disclosure describes a liquid mirror including: a liquid; a support structure defining an outer surface configured to support the liquid; and a plurality of reflective particles configured to self-assemble at an interface between the liquid and an external environment or between the liquid and the outer surface, wherein the outer surface and the liquid are configured to cause the plurality of reflective particles to form a focusing shape via capillary action of the liquid; and a thermal controller configured to cool a portion of the surface area of the outer surface to a temperature sufficient to immobilize the liquid to maintain the focusing shape of the interface.

The details of one or more examples are set forth in the accompanying drawings and the description below. Other features, objects, and advantages will be apparent from the description and drawings, and from the claims.

### BRIEF DESCRIPTION OF THE FIGURES

FIG. 1 is a schematic cross-sectional view of an example optical system including a liquid mirror.

FIG. 2A is a schematic cross-sectional view of an example a liquid mirror.

FIG. 2B is a schematic cross-sectional view of another example a liquid mirror.

FIG. 2C is a schematic cross-sectional view of another example a liquid mirror.

FIG. 3A is a structural formula diagram of an example ionic liquid.

FIG. 3B is a structural formula diagram of another example ionic liquid.

FIG. 4 is a schematic illustration of an example orbit of a vehicle including a liquid mirror.

FIG. 5A is a schematic cross-sectional view of a portion of an example liquid mirror without an applied magnetic field.

FIG. 5B is a schematic cross-sectional view of a portion of the example liquid mirror of FIG. 5A in the presence of an applied magnetic field.

FIG. 5C is a schematic cross-sectional view of a portion of the example liquid mirror of FIG. 5A in the presence of a spatially varying applied magnetic field.

FIG. 6 is a flow diagram illustrating an example technique of making a liquid mirror.

### DETAILED DESCRIPTION

Use of mirrors for telescopes in space and/or on Earth is well-established, but the use of mirrors including solid polished reflectors create a large number of challenges. The cost of making mirrors including solid polished reflectors may increase exponentially with increasing mirror diameter, and these mirrors may be relatively easily damaged by contact with debris.

Use of a liquid mirror (LM) for a telescope may be significantly less expensive, more robust, and more rapidly deployed compared to solid mirrors and/or mirrors including polished reflectors. Instead of an exponential increase, the cost of making a liquid mirror may increase substantially linearly with increasing mirror diameter, compared to solid mirrors. Unlike solid mirrors, liquid mirrors may be able to “heal” after contact with debris or after other disturbances of the liquid surface or reflecting surface (e.g., interface) from other forces, e.g., wind, vibration, or the like.

A satellite equipped with a liquid mirror telescope (LMT) including a liquid mirror, or an ionic liquid mirror, might be employed for orbital debris monitoring, observation of space vehicles, Earth observation, deep-space optical communication, as an astronomical observatory or other applications. A liquid mirror may not be affected by stresses involved in launch, e.g., because a liquid mirror may be deployed post-launch in space and, as also observed on Earth, a liquid surface can be inherently smooth and self-healing.

Earth-based large diameter liquid mirrors may rely on Earth's gravity to help form the liquid into the desired shape (e.g., paraboloid). The surface of a liquid in equilibrium is a constant potential energy surface, which is why most liquids lie flat under the influence of gravity. However, when rotated at a constant angular velocity about a vertical rotation axis, the equipotential surface takes the form of a paraboloid, a shape that focuses light. Light incident upon a reflective liquid surface spinning at a constant angular velocity converges at an effective prime focal point.

An Earth-based liquid mirror that is rotated or spun may not be tilted in operation relative to a gravitational force or other force (e.g., acceleration force) and thus may not be pointed in arbitrary directions from the ground, or in an arbitrary direction in space. For example, an Earth-based LMT may only point straight upward and may only be capable of observing objects at the zenith, e.g., are non-tiltable without the introduction of other forces to shape the liquid when pointed off-normal. Space-based LMTs may substitute spacecraft thrust for gravity but are optically limited by containment systems to prevent the liquid component from boiling off in vacuum. For example, Earth-based liquid mirrors may be made using liquid metals, e.g., mercury, which may be too volatile for use in space, e.g., because such liquids may evaporate. A rotating/spinning LMT may also require highly complex controlled spinning assemblies in operation, and by spinning these surface shapes are limited to predictable parabolic shapes.

Therefore, systems and materials systems are needed that permit formation of high-quality liquid mirrors without spinning and that can be transformed into semi-solid or solid stable durable forms by virtue of their materials properties and by the appropriate system design and operation. Such systems and materials system may then permit pointing of liquid mirrors in arbitrary direction from the ground or space and under conditions of arbitrary transverse forces. Systems are further begged that permit repeated healing said mirror surfaces should they encounter damage in use; to repeatedly restore their high optical quality.

In general, the present disclosure describes systems, devices, and methods for formation or use of liquid mirrors, that are operable without requiring spinning. In some examples, example liquid mirrors are transformed into semi-solid or solid stable durable forms by virtue of materials properties and by the appropriate system design and operation, e.g., cooling and/or heating. Example liquid mirrors described herein may enable pointing of the liquid mirror in an arbitrary direction from the ground or space (e.g., relative to a direction of travel or acceleration of a space vehicle) and under conditions of arbitrary transverse forces. Example liquid mirrors describe herein may be configured to repeatedly heal one or more mirror surfaces should a surface be damaged in use, e.g., by debris, to repeatedly restore a high optical quality of the mirror. For example, the mirror may include materials that may be in a liquid state to absorb and/or move debris or damage from a reflecting surface of the liquid mirror, and optionally re-solidified after mitigation of the debris and/or damage.

Liquid mirrors described herein may enable facile formation of diverse mirror and/or surface shapes without requiring complex spinning assemblies, and in some examples use available gravity (e.g., for ground or Earth-based applications) or induced centrifugal forces (e.g., for space-based applications). In some examples, liquid mirrors described herein provide improved tracking and characterizing of objects in space by providing a deployable large diameter, self-healing, self-forming liquid mirror that may be pointed in an arbitrary direction relative to one or more forces on the mirror.

In accordance with the system, devices, and techniques described herein, a liquid mirror includes at least one liquid and a plurality of reflective particles configured to self-assemble to form a predetermined shape, such as a focusing shape. In some examples, the reflective particles are configured to self-assemble at an interface, e.g., a top interface of the liquid, or an interface between the liquid and a support structure configured to contain and/or retain the liquid. In some examples, the liquid mirror includes a plurality of liquids, e.g., a first liquid, a second liquid immiscible with the first liquid and configured to define an interface between the first liquid and the second liquid, and a plurality of reflective particles configured to self-assemble at an interface between the first and second liquids. The liquid mirror also includes a support structure defining an outer surface configured to support the liquid or liquids, e.g., the first liquid and the second liquid. The outer surface and the liquid, or the first liquid and the second liquid, may be configured to cause the plurality of reflective particles to form a focusing shape via capillary action of the liquid, or the first liquid and second liquids, and interaction with the support structure. In some examples, the liquid is a non-volatile liquid which may be an ionic liquid, or a non-ionic liquid, e.g., such as a high molecular weight oil. In some examples, the first and second liquids are immiscible ionic liquids having effectively zero (e.g., negligible) vapor pressure suitable for space applications.

In some examples, the outer surface defined by the support structure has a relatively “rough,” or approximate, focusing shape, e.g., a roughly paraboloidal, hyperboloidal, spherical, or other suitable concave mirror focusing shape. When deployed, the first and second liquids overlay the outer surface and form the final, high-optical quality focusing shape via their interface and reflective particles.

In some examples, when the first and second liquids are not deployed, the support structure is configured to house the first liquid and the second liquid or may include a reservoir apparatus configured to house the first liquid and the second liquid, e.g., within a reservoir such as a liquid housing, a tank, or the like. The reservoir may be within the support structure and/or coupled to the support structure. The reservoir may be at least partially filled with diverse liquids, e.g., at least the first liquid and/or the second liquid.

In some examples, the liquid mirror is configured to deploy the first and second liquids to the outer surface of the support structure or withdraw the first and second liquids from the outer surface of the support structure, e.g., from and/or to the reservoir. For example, the support structure may define at least one conduit fluidically coupling the outer surface with the reservoir. The at least one conduit may be one or more lumen or one or more pore fluidically coupling the outer surface with the reservoir. In some examples, at least a portion of the support structure is porous and fluidically couples the outer surface and the reservoir.

In some examples, the support structure or the reservoir includes a pump configured to increase or decrease a pressure within the reservoir. For example, the support structure may include a pump (or the pump may be attached to the support structure) that is fluidically coupled to the reservoir. When the pump increases a pressure within the reservoir, the first and second liquids may be forced to a lumen or a pore of the support structure. The lumen and/or pore may be configured such that the first and second liquids move from the reservoir to the outer surface via capillary action, or the first and second liquids may wick via porous structure of the support structure from the reservoir to the outer surface. When the pump decreases a pressure within the reservoir, the first and second liquids may move from the outer surface to the reservoir via capillary action, or the first and second liquids may wick via porous structure of the support structure from the outer surface to the reservoir.

In some examples, thermal controllers increase or decrease a temperature of the support structure defining the conduit(s) (e.g., lumen(s) or pore(s)) to increase or decrease a rate of movement, capillary action, and/or wicking of the liquid between the reservoir and the outer surface. For example, to deploy the first and second liquids, the pump may increase a pressure within the liquid housing such that the first and second liquids may enter a conduit defined by the support structure. A thermal controller may increase a temperature of the support structure defining the conduit to increase the movement, capillary action, and/or wicking of the first and second liquids through the conduit (e.g., lumen or pore) to the outer surface, or to decrease a temperature of the support structure defining the conduit to decrease the movement, capillary action, and/or wicking of the first and second liquids through the conduit to the outer surface. In some examples, the liquid mirror includes a plurality of thermal controllers configured to independently control the temperature of the support structure defining conduits of different portions (e.g., volumes) of the support structure. For example, the plurality of thermal controllers may be distributed on or through the support structure to control the rate of movement, capillary action, and/or wicking of the first and second liquids, via controlling the temperature of the support structure, as a function of position of the outer surface.

In some examples, the liquid mirror is configured to form the liquid mirror shape (e.g., focusing shape) after deploying the first and second liquids to the outer surface of the support structure. For example, the first and second liquids may have material properties that, in conjunction with surface properties of the outer surface, are configured to induce capillary action by the first and second liquids across the outer surface and causing the interface of the first and second liquids (and reflective particles self-assembled at the interface) to form the focusing shape, e.g., without spinning or a gravitational or centrifugal force. For example, the capillary action may cause the first and/or second liquid to move along the outer surface of the outer support structure without, or in opposition to, a gravitational or centrifugal force.

In some examples, the liquid mirror includes one or more thermal controllers configured to heat and/or cool at least a portion of the surface area of the outer surface. For example, the liquid mirror may include a plurality of thermal controllers distributed so as to heat and/or cool portions of the surface area of the outer surface as a function of position. The thermal control of the outer surface, e.g., as a function of position, may increase or decrease a rate of movement and/or capillary action of the first and second liquids on the outer surface to form a predetermined shape (e.g., the focusing shape) of the interface between the first and second liquids. For example, heating or cooling a portion of the outer surface (via the thermal controllers) may increase or decrease the capillary action of the first and second liquids along the portion, which may control the shape interface of the first and second liquids, e.g., to form at least a portion of the final liquid mirror shape, which may be the focusing shape. In some examples, a plurality of thermal controllers is configured to heat and/or cool a plurality of portions of the outer surface to induce a predetermined temperature variation and/or profile across the surface area of the outer surface to control capillary action of the first and second liquids. For example, the thermal controllers may be configured to control the interface between the first and second liquids (e.g., the reflecting surface of the liquid mirror) via temperature control in order to form a non-focusing shape, a focusing shape including wavefront correcting variations (e.g., an adaptive shape configured to increase the modulation transfer function of the liquid mirror), or any suitable shape.

In some examples, the liquid mirror includes one or more thermal controllers that may individually control one or both of the temperature of one or more conduit defined by the support structure or at least a portion of the surface area of the outer surface. For example, the liquid mirror may include a plurality of thermal controllers that may each control a temperature of both a portion of the lumens or porous volume of the support structure and a portion of the surface area of the outer surface.

In some examples, the liquid mirror is configured to control the temperature of the outer surface as a function of position in conjunction with adding or removing a volume of the first and/or second liquids as a function of position. For example, the liquid mirror may be configured to control the capillary action of the first and second liquids on the outer surface via temperature and/or liquid volume control so as to take advantage of the capillary action at the outer radial edges of the outer surface to pull the first and second liquids radially outwards by surface tension. In some examples, the liquid mirror is configured to deploy the first and second liquids to progressively form a predetermined shape (e.g., focusing shape) of the interface by control of the distributed temperatures throughout the support structure and the first and second liquids and in conjunction with controlled addition and/or removal of the first and second liquids to/from the outer surface. The liquid mirror may also be configured to cool the outer surface and first and second liquids to progressively fix the surface shape of the interface and transform the first and second liquids into a solid or semi-solid durable state. In some examples, the liquid mirror is configured to repeatedly add and/or remove the first and second liquids at portions of the outer surface, along with cycling the heating and cooling of portions of the outer surface, to effect more difficult surface shapes.

In some examples, the liquid mirror is configured to form the surface shape of the interface of the first and second liquids, e.g., as described above, along with a finite force anti-aligned with the surface normal at the radial center of outer surface. For example, the finite force may be some fraction of the force provided by gravity, or some centrifugal force by virtue of rotation about a center of mass of the support structure, either in a finite gravity background, or a micro-gravity environment such as in space. The effect of transverse forces may be employed to form alternate and non-symmetric surfaces in three dimensions. For example, for forces anti-aligned with the surface normal at the radial center of the outer surface, the liquid mirror may be configured to form a surface shape of the interface that is substantially symmetric azimuthally near the radial center in a cylindrical or spherical coordinate systems, and may be described as a two-dimensional surface near the radial center and extended to the edges with perfectly circular edges. In some examples, with non-circular edges, the surface shape of the interface is asymmetric in a direction toward the radial edges of the outer surface, such as segmented line segments.

In some examples, the liquid mirror is configured to form and reform relatively arbitrary liquid surface shapes of the interface between the first and second liquids, as well as repeated healing of the top surface and interface of the first and second liquids to restore optical quality of the interface if it is damaged in use. In some examples, the first and second liquids are hygroscopic, and the liquid mirror is configured to control the atmosphere (e.g., temperature, humidity, and/or oxygen and water scavenging) above and/or adjacent to the outer surface of the first and second liquids, e.g., for an Earth-based liquid mirror which may be open and exposed to the environment.

In some examples, the first and second liquids are ionic liquids. Ionic liquids are non-volatile and may not evaporate in space, e.g., substantially outside of the Earth's atmosphere. Ionic liquids may be salts, typically organic salts, which may have melting points near room temperature, or well below room temperature on Earth. In other examples, when used in space, first and second liquids may be organic salts having melting points above room temperature (on Earth). In some examples, the first and second liquids may be ionic liquids having effectively zero (e.g., negligible) vapor pressure, and offer the capability of a liquid mirror that can have long term durability in space.

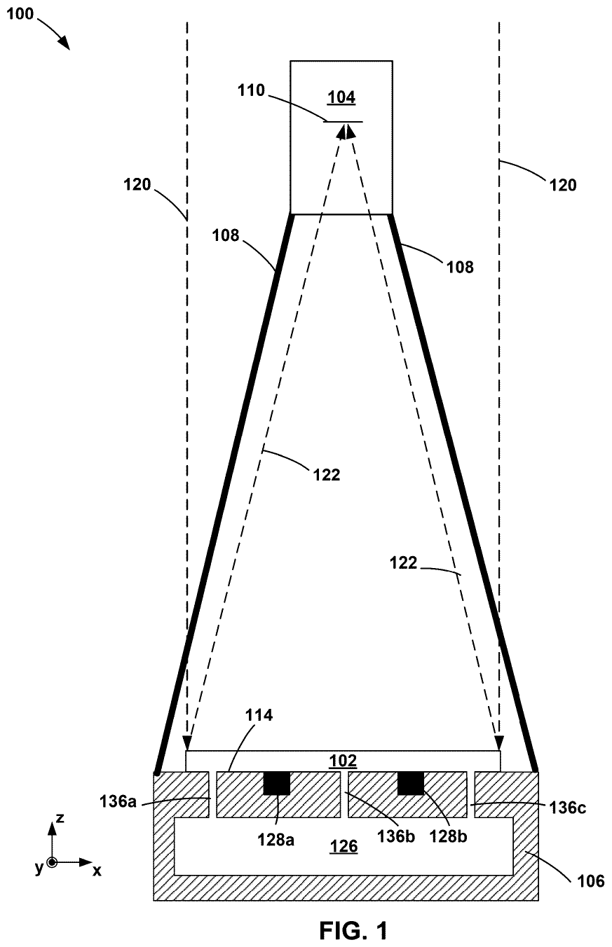

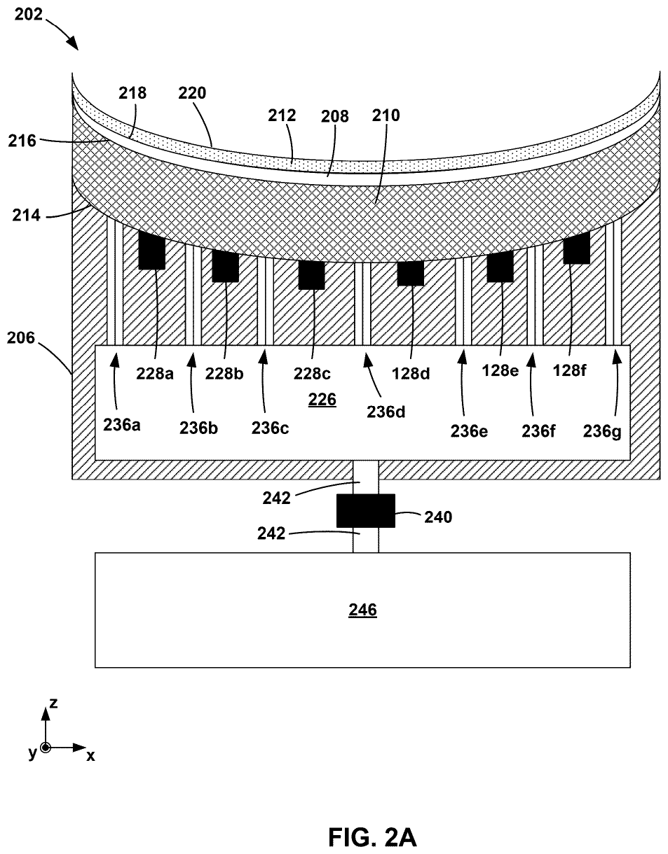

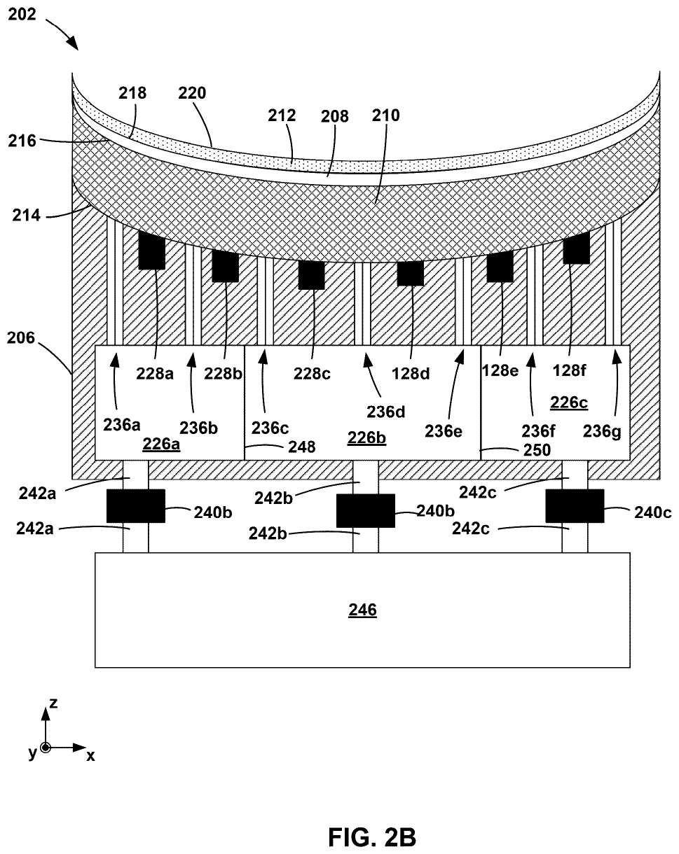

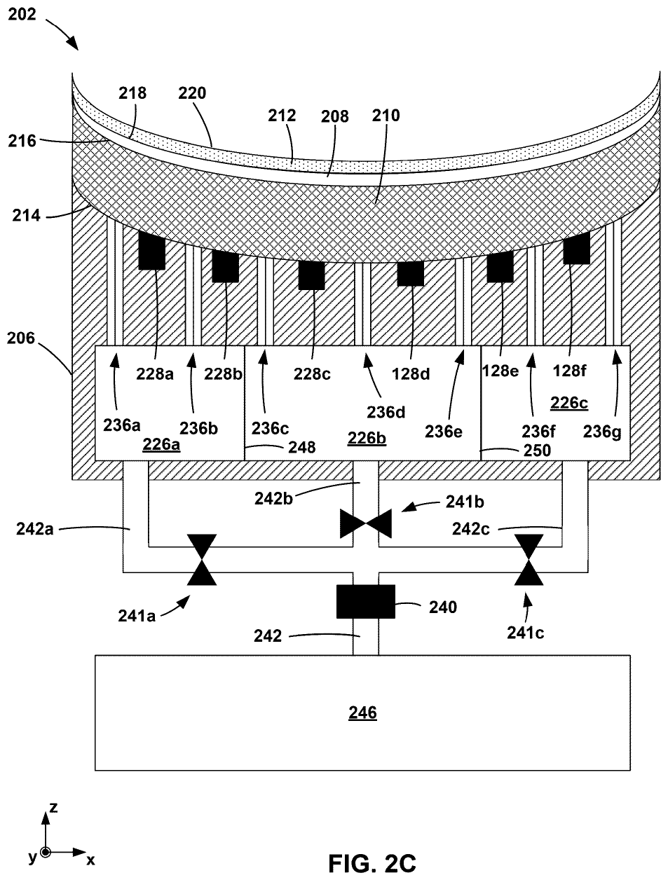

FIG. 1 is a schematic cross-sectional view of an example optical system 100 including a liquid mirror 102. FIGS. 2A-2C are a schematic cross-sectional views of example liquid mirror 202 and support structure 206 with varying pump and reservoir configurations. FIGS. 1-2C are described together below. In the examples shown, optical system 100 may be at least a portion of a LMT which may be attached to, carried by, or included with a vehicle, e.g., a space or aerial vehicle.

Referring to FIG. 1, optical system 100 includes liquid mirror 102, mirror support structure 106, detection module 104, and struts 108 which may be configured to support, position, and hold detection module 104 relative to support structure 106 and liquid mirror 102.

Detection module 104 may include re-imaging optics, e.g., any suitable optical elements including lenses, flat mirrors and/or focusing or non-focusing curved mirrors, diffractive and/or holographic optical elements, windows, spatial and/or spectral filters, or the like. Detection module 104 may also include focal plane 110. For example, liquid mirror 102 may be configured to, in conjunction with detection module 104, focus incident light 120 to focal plane 110. Focal plane 110 may be flat or curved. Focal plane 110 may include a focal plane array configured to capture an image of a scene via incident light 120, e.g., a focal plane array of a camera.

Liquid mirror 102 is configured to reflect incident light 120 to optical detection module 104, e.g., as reflected light 122. In some examples, liquid mirror 102 has optical power to converge or diverge incident light 120. For example, liquid mirror 102 may have a reflecting surface having a curved shape, such as a spherical or parabolic two-dimensional shape or one-dimensional (e.g., cylindrical) shape. In some examples, liquid mirror 102 is a primary mirror of an LMT, and detection module 104 includes a secondary mirror or lens of the LMT.

Support structure 106 and struts 108 may be configured to provide mechanical support and positioning of liquid mirror 102 and detection module 104, e.g., to maintain the positions and optical axes of liquid mirror 102 and detection module 104 relative to each other.

Support structure 106 may include reservoir 126 and thermal controllers 128a, 128b (collectively, “thermal controllers 128”). Reservoir 126 is configured to hold, house, store, and/or contain one or more liquids including liquid mirror 102, e.g., when liquid mirror 102 is not deployed or is in an undeployed state, such as during transport of system 100.

Support structure 106 defines outer surface 114. Outer surface 114 is configured to support liquid mirror 102, e.g., to support one or more liquids including liquid mirror 102. Support structure 106 also defines conduits 136a, 136b, 136c (collectively, “conduits 136”) fluidically coupling outer surface 114 and/or liquid mirror 102 to reservoir 126. In some examples, conduits 136 include a plurality of lumens defined by support structure 106, and in other examples, conduits 136 include a plurality of pores defined by support structure 106. For example, at least a portion of support structure 106 may be porous fluidically coupling outer surface 114 and/or liquid mirror 102 and reservoir 126. Conduits 136 may include both one or more lumen and one or more pore.

In some examples, one or both of support structure 106 or reservoir 126 include pump 240 (FIG. 2A). Pump 240 may be configured to deploy or withdraw one or more liquids to or from reservoir 126, e.g., from or to a separate auxiliary reservoir 246 (FIG. 2A) or an external environment (not shown), to increase or decrease a respective volume of the one or more liquids along at least a portion of outer surface 114. For example, to deploy a liquid from reservoir 126 to outer surface 114, pump 240 may be configured to provide a motive force to a liquid or increase a pressure within reservoir 126 causing a liquid to move, to conduits 136, and in some examples to push a liquid through conduits 136 to outer surface 114. In some examples, pump 240 causes the liquid to move to conduits 136, but not push the liquid through conduits 136, and the liquid may move through conduits 136 via capillary action and/or wicking to outer surface 114. To withdraw a liquid from outer surface 114, pump 240 may be configured to decrease a pressure within reservoir 126, thereby drawing the liquid through conduits 136 via capillary action, wicking, and/or a pressure differential to reservoir 126.

Support structure 106 may include one or more thermal controllers 128a, 128b (collectively, “thermal controllers 128”). Thermal controllers 128 may be configured to heat or cool at least a portion of the surface area of outer surface 114. In the example shown, thermal controllers 128 are distributed about the area of outer surface 114, and may be positing on outer surface 114 and/or adjacent to outer surface 114. In some examples, thermal controllers 128 include one or more of any of a heating element, a Joule heater, a power resistor, a heater resistor, a ceramic heating element, a metal heating element, a thick film heating element, a polymer positive temperature coefficient heating element, a composite heating element, a cooling element, a thermoelectric cooler, a thermocycler, any suitable heating element, or any suitable cooling element.

Referring to FIG. 2A, liquid mirror 202 may include a first liquid 212, reflective layer 208, and second liquid 210. In some examples, first liquid 212 and second liquid 210 are ionic liquids. In the example shown, liquid mirror 202 is deployed, or in a deployed configuration or state, with first liquid 212 and second liquid 210 on a support structure 206 defining an outer surface 214, e.g., liquid mirror 102 is directly adjacent to and in contact with outer surface 214. Liquid mirror 202, support structure 206, and outer surface 214 may be substantially similar to liquid mirror 102, support structure 106, and outer surface 114 described above, except for the differences described herein. In some examples, system 100 includes liquid mirror 202.

Outer surface 114 may be a front surface (e.g., a forward-facing surface facing incident light 120) that may have a shape, e.g., flat, curved, spherical, parabolic, hyperbolic, or the like. In the example shown, outer surface 114 forms an interface with second liquid 210. Reflective layer 208 may include a plurality of reflective particles that are configured to self-assemble at an interface between first liquid 212 and second liquid 210, e.g., forming interface 216 between reflective layer 208 and second ionic liquid 210 and interface 218 between reflective layer 208 and first ionic liquid 212.

In some examples, reflective layer 208 has a thickness (e.g., nominally in a direction towards support structure 206, e.g., the z-direction substantially in the middle of liquid mirror 202) that is less than about 10 micrometers, or less than about 1 micrometer, or less than about 500 nanometers, or less than about 100 nanometers, or less than about 50 nm, or a thickness that is about the nominal size of the thickness of the reflective particles (e.g., a “single layer” of reflective particles). In some examples, interfaces 216 and 218 forms a single interface (referred to herein as interface 216) between liquids 212, 210. In some such examples, reflective layer 208 includes a collection of particles or nanoparticles with sufficient surface density at interface 216 to have sufficient reflectivity (e.g., as opposed to a “layer”). In the example shown, first liquid 212 may have a top surface 220 which may be flat, curved (as shown), or have any surface profile, e.g., top surface 220 may not appreciably contribute to reflecting incident light 220 and/or image formation using liquid mirror 202. In some examples, first liquid 212 has a thickness that is less than about 100 micrometers, or less than about 10 micrometers, or less than about 1 micrometer, or less than about 100 nanometers. Second liquid 210 may have a thickness that is less than about 10 millimeters, or less than about 5 millimeters, or less than about 1 millimeter, or less than about 500 micrometers.

In some examples, to allow liquid mirror 202 to be operable under the vacuum and temperatures of space, ionic liquids for both first liquid 212 and second liquid 210 are used. Reflective particles or nanoparticles may self-assemble at interface 216 between the two ionic liquids, forming reflective layer 208. The top ionic liquid layer (e.g., relative to incident light 120 and shown as first liquid 212) may be relatively thin, e.g., having a minimized thickness, to avoid attenuating incident light 120 reaching reflective layer 208, while the base ionic liquid layer (e.g., shown as second ionic liquid 210) may be configured to provide the optical-quality surface, e.g., which may be at interface 216. Outer surface 214 of support structure 206 need not have wavefront accuracy, e.g., it may only be accurate to 100's of microns, while liquid interface 216 follows the shape dictated by capillary action, thermal controllers 228, pump 240, and/or external forces such as gravitational and/or centrifugal forces that may be present (e.g., which may be in the zenith or z-direction as shown). In some examples, liquid mirror 202 is configured to define a paraboloid shape having a suitable wavefront accuracy, e.g., to an accuracy much less than 1 micron, over the area of mirror 202 and/or the area of reflective layer 208. In some examples, mirror base 204 includes permanent and/or tunable magnets (not shown).

In some examples, liquids 212, 210 are configured to allow control of density, viscosity, surface tension, vapor pressure, thermal conductivity, melting point, surface contact angle (e.g., with a surface of a housing and/or the support structure), interfacial contact angle (e.g., between the liquids at interface 216), and any other suitable property. For example, first liquid 212 may be 1-butyl-3-methylimidazolium acetate (BMIM Ac), which may be transparent (e.g., for light having at least visible wavelengths), may have a melting point of about −77° C. (e.g., about 196 Kelvin), a viscosity of about 297 millipascal-seconds (mPa-s) at room temperature, and a surface tension of about 36 milli-Newtons per meter (mN/m). In some examples, the liquid properties allow liquids 212, 210 to flow during deployment (e.g., formation) of the liquid mirror 202, to avoid freezing during subsequent use, and/or to require low power input for maintenance of the paraboloid reflective layer 208 once formed. In some examples, BMIM Ac (and other ionic liquids) have negligible volatility and may be exposed to the vacuum of space substantially without evaporation from the surface. In some examples, BMIM Ac (and other ionic liquids) are sensitive to temperature, such that upon cooling, a glass-like material may be generated and/or formed on the surface of liquid 212 and/or 210, and/or the entire volume of liquids 212 and/or 210 may form a glass-like material. For example, a transparent and substantially defect-free glass-like material may be formed on the surface to further simplify LMT operations.

In some example, liquid mirror 202 may be formed by introducing a material, e.g., from above liquid mirror 202. For example, spraying or spray coating, flowing, sputtering, atomic deposition techniques, or the like, may be used to form liquid mirror 202, e.g., atomic deposition is used to create the reflective surface. In other examples, a self-assembly technique/process, or any suitable different technique/process, may be used to create the reflective surface and/or form liquid mirror 202. For example, BMIM Ac is soluble in water, and the processes necessary to make or suspend metallic nanoparticles may be completed in a neat ionic liquid (e.g., in neat BMIM Ac), in an ionic liquid-water solution from which the water may be subsequently evaporated, or via any suitable method of suspending and distributing the nanoparticles.

In some examples, second liquid 210 is a second phase of first liquid 212, or first liquid 212 is a second phase of second liquid 210. For example, a hydrophobic phosphonium ionic liquid is immiscible with hydrophilic imidazolium ionic liquids like BMIM Ac, and mixing the two may generate two liquid phases separated by an interface 216, e.g., via a mixing device that may apply a shear to make sure that the surfaces of the particles of reflective layer 208 are fully exposed to the two liquids (or in some examples, shaking a mixture of the two generates two liquid phases separated by an interface). In some examples, second liquid 210 is also optically transparent, have a lower density than first liquid 212, have a low melting point, and may have a viscosity configured for forming the mirror, e.g., to flow to a paraboloid shape configured to focus light to a predetermine focal point or range of focal points. In some examples, each of the first and second mutually immiscible liquids 212, 210 have at least one matched anion. In some examples, first ionic liquid 212 includes a hydrophobic cation, such as a hydrophobic phosphonium cation, and second ionic liquid 210 includes a hydrophilic cation, such as a hydrophilic imidazolium cation.

In some examples, the material of support structure 206 is selected to aid in liquid self-assembly and liquid mirror chemical and physical stability. For example, support structure 206 may have a hydrophilic top surface, e.g., at outer surface 214, which may induce the more hydrophilic ionic liquid (e.g., of the two ionic liquids or phases, which may be second ionic liquid 210) wet outer surface 214 and form the “base layer,” e.g., second liquid 210. The other liquid and/or phase (e.g., first liquid 212) may be pushed to the top. The attraction between the two hydrophilic materials of first and second liquids 212, 210 may help hold liquid mirror 202 in place. Chemical stability may also be provided by appropriate material selection. For example, since ionic liquids are conductive, they may tend to corrode metal surfaces if the liquid is in contact with multiple metals. To avoid corrosion of the reflective particles and/or outer surface 214, and/or to improve the hydrophobic or hydrophilic properties of the reflective particles to improve forming the reflective layer 208 (and if the surface is metallic), it may be beneficial to coat the reflective particles and/or the parabolic surface in a hydrophilic (or hydrophobic) organic material. In some examples, e.g., in space, liquids 212, 210 are exposed to solar radiation or ionizing cosmic radiation, and materials may be selected that are more durable to this exposure. In some examples, the reflective particles of reflective layer 208 include gold, silver, or other particles or nanoparticles.

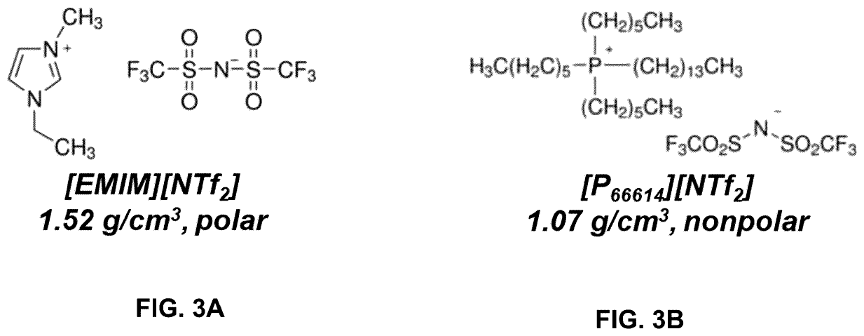

FIG. 3A is a structural formula diagram of an example ionic liquid, and FIG. 3B is a structural formula diagram of another example ionic liquid. FIGS. 3A and 3B are described together below. The ionic liquids for FIGS. 3A, 3B may be examples of first liquid 212 and/or second liquid 210.

In some examples, one or both of the first and second liquids 212, 210 are polar or nonpolar. For example, as shown in FIGS. 3A and 3B, an ionic liquid mixture may include 0.3-0.99 (or just under 1.00) mol fraction of 1-ethyl-3-methylimidazolium bis(trifluoromethylsulfonyl)amide ([EMIM][NTf2]) in trihexyltetradecylphosphonium bis(trifluoromethylsulfonyl)amide ([P66614][NTf2]), which forms two phases at 20-120° C., e.g., a first phase illustrated in FIG. 3A and a second phase illustrated in FIG. 3B.

In some examples, liquid pairs 212, 210 are selected based on criteria including one or more of mutual insolubility, density difference, polarity (e.g., dielectric constant) difference (frequently assessed as a difference in surface tension) and/or other criteria. In some examples, the anion for each liquid 212, 210 are the same as that for the other one, to avoid generating mixed pairs. The anion may include one or more of bis(trifluoromethylsulfonyl)amide, bismethanysulfonylimide, bis(perfluoroethylsulfonyl)imide, trifluoroethanesulfonate, hexafluorophosphate, or tetrafluoroborate, or the like. The cations for the nonpolar cation may include tetraalkylphosphonium and tetraalkyl ammonium with the alkyl groups separately containing between 4 and 20 carbons. Cations for the polar cation may be selected from 1,3-dialkylimidazolium, N,N-dialkyl pyrrolidinium and N-alkylpyridinium cations, and the like, where “alkyl” refers to alkyl groups with less than 4 carbons and may include hydroxylalkyl groups.

In some examples, [EMIM][NTf2] in [P66614][NTf2] have a density of about 1.52 g/cc, a viscosity at 20° C. of about 35.5 centipoise (cP) and a surface tension of about 41.6 mN/m.

Referring back to FIG. 2A, in some examples, a self-assembled LMT includes liquid mirror 202 and may be deployed and regenerated in space. For example, a LMT may be launched with first and second liquids 212, 210 in reservoir 226. Reservoir 226 may be substantially similar to reservoir 126 of FIG. 1, except for the differences described herein. In the example shown, reservoir 226 may be fluidically coupled to auxiliary reservoir 246 via conduit 242 and pump 240. Auxiliary reservoir 246 may be configured to hold, house, store, and/or contain a fluid, e.g., first and second liquids 212, 210, and/or a different liquid or gas. Pump 240 may be configured to move a fluid between reservoir 226 and auxiliary reservoir 246 to change a pressure within reservoir 226 and cause first and second liquids 212, 210 to move through conduits 236.

Support structure 206 may define a plurality of conduits 236a-236g (collectively, “lumens 236”). In some examples, instead of conduits 236, support structure 206 defines a plurality of lumens fluidically coupling outer surface 214 and reservoir 226. In other examples, conduits 236 include a plurality of pores fluidically coupling outer surface 214 and reservoir 226, e.g., at least a portion of support structure 206 may be porous. In some examples, conduits 236 include both lumens and pores.

In some examples, liquid mirror 202 is configured to be deployed after the LMT has reached its target orbit. For example, pump 240 may increase a pressure within reservoir 226 and/or cause first and second liquids 212, 210 to flow to conduits 228, e.g., by drawing a fluid from auxiliary reservoir 236 via conduit 242. Support structure 206 may be configured to cause first and second liquids 212, 210 to move within conduits 236 via capillary action and/or wicking to deploy and/or disperse and/or dispense first and second liquids 212, 210 across the surface area of outer surface 214. For example, the lumens and/or pores of conduits 236 may be sized such that first and second liquids 212, 210 may move within conduits 236 via capillary action, e.g., conduits 228 may have an effective diameter and/or an effective cross-sectional area that is small enough that cohesion and adhesion of the liquid molecules of first and second liquids 212, 210 cause first and second liquids 212, 210 to move within conduits 136 via capillary action. In some examples, the material properties of first and second liquids 212, 210, e.g., polarities (dielectric constants), surface tensions, densities, refractive indices, and the like, operate in conjunction with surface properties of the inner wall surfaces of conduits 236. For example, the inner wall surfaces of conduits 236 may have a surface energy and/or adhesion with first and second liquids 212, 210 conducive to capillary action by the first and second liquids 212, 210 through conduits 236. In some examples, the material properties of the reflective particles may impact how the first and second liquids 212, 210 interact at the interface (of the liquids and/or inner surfaces of the conduits). In some examples, surface structure of the inner surfaces of conduits 236 may impact adhesion and/or wetting of first and second liquids 212, 210 (e.g., surface contact angle) and capillary action by first and second liquids 212, 210. For example, the inner surfaces of conduits 236 may have regular or irregular microstructure and/or nanostructures configured to increase and/or decrease capillary action of first and second liquids 212, 210 within conduits 236.

In the example shown, support structure 206 includes a plurality of thermal controllers 228a-228f (collectively, “thermal controllers 228”). Thermal controllers 228 may be substantially similar to thermal controllers 128 described above. In some examples, thermal controllers 228 are configured to heat or cool at least a portion of the surface area of outer surface 214, or to heat or cool at least a portion of conduits 236, or to heat or cool at least a portion both outer surface 214 and conduits 236. For example, thermal controllers 236 may be configured to control the surface temperature of the inner wall surfaces of conduits 236, and/or the temperature of first and second liquids 212, 210 within conduits 236, or both, (e.g., via conduction between surfaces of conduits 236 and first and second liquids 212, 210), to control a rate of capillary action within conduits 236 and/or whether first and second liquids 212, 210 are able to move within conduits 236 via capillary action.

For example, thermal controllers 228 may control the temperature of surfaces of conduits 236 and/or the temperature of first and second liquids 212, 210 to be greater than a maximum threshold temperature at which first and second liquids 212, 210 may move via capillary action. In some examples, thermal controllers 228 are configured to control the temperatures of conduits 236 and/or first and second liquids 212, 210 such that first and second liquids 212, 210 do not have sufficient cohesion and/or adhesion to conduits 236 to resist capillary action caused by surface tension and the polarity of first and second liquids 212, 210. In some examples, thermal controllers are configured to control the temperatures of conduits 236 and/or first and second liquids 212, 210 to be less than a minimum threshold temperature at which first and second liquids 212, 210 may move via capillary action (e.g., first and second liquids 212, 210 have too great a cohesion/adhesion). In some examples, thermal controllers 228 are configured to heat a portion of the surface area of outer surface 214 to a temperature sufficient to liquify and/or mobilize at least one of first liquid 212 or second liquid 214 to allow the at least one of first liquid 212 or second liquid 214 to flow to change the shape of interface 216 and/or reflective layer 208.

Whether by motive force, pressure from pump 240, or capillary action within conduits 136, first and second liquids 212, 210 may exit conduits 236 to deploy, disperse, or dispense, about the surface area of outer surface 214. In some examples, first and second liquids 212, 210 dispense or disperse about the surface area of outer surface 214 via capillary action, e.g., first and second liquids 212, 210 may move to cover outer surface 214 to a predetermined thickness and/or shape, e.g., without spinning support structure 206 and/or in the absence of a gravitational and/or centrifugal force. For example, first and second liquids 212, 210 may have material properties, e.g., cohesion, polarity, and surface tension, and may interact with outer surface 214 (e.g., via adhesive properties between first and second liquids 212, 210 and outer surface 214), and may be immiscible with each other, so as to form interface 216 and/or reflective layer 208 having a predetermined shape, e.g., a focusing shape. In some examples, first and second liquids 212, 210 may have an interfacial tension, e.g., due to van der Waals or polar forces, such that first and second liquids 212, 210 form interface 216 and/or reflective layer 208 having a predetermined, focusing, shape. In some examples, liquid mirror 202 and support structure 206 are configured to define a mirror diameter of at least 5 meters and a focusing shape of interface 216 and/or reflective layer 208 such that a ratio of the effective focal length of liquid mirror 202 to the diameter of the entrance pupil of liquid mirror 202 (e.g., the aperture stop, f-stop, or F/# of liquid mirror 202) is F/8 or less, or F/4 or less, or F/2 or less.

In some examples, thermal controllers 228 are configured to heat or cool portions of outer surface 214 so as to increase, decrease, stop, or start capillary action of first and second liquids 212, 210, e.g., to control formation of the focusing shape of interface 216 and/or reflective layer 208. In some examples, thermal controllers 228 are configured to work in conjunction with pump 240 to form the focusing shape, adjust the shape as a function of position about the area of outer surface 214, change the shape of interface 216 and/or reflective layer 208, heal interface 216 and/or reflective layer 208 in case of damage, and/or form any suitable predetermined focusing or non-focusing shape of interface 216 and/or reflective layer 208. For example, thermal controllers 236 may be configured to independently control the temperature of portions of the surface area of outer surface 214 and portions of conduits 236 to control the flow of first and second liquids 212, 210 within conduits 236 (e.g., by capillary action and/or pressure differential) to add or remove first and second liquids 212, 210 to certain areas of outer surface 214, and to control the flow of first and second liquids 212, 210 along certain portions of outer surface 214 (e.g., via capillary action) to control the thicknesses of first and second liquids 212, 210 as a function of position about the area of outer surface 214 and ultimately control the shape of interface 216 and/or reflective layer 208 to be any suitable predetermined shape. In some examples, thermal controllers 228 are configured to increase the viscosity of first and second liquids 212, 210, e.g., via cooling, such that first and second liquids 212, 210 substantially do not flow, e.g., without freezing and/or solidifying first and second liquids 212, 210.

In some examples, surface tension and interfacial tension contribute to holding the liquid (e.g., second ionic liquid 210) against the surface (e.g., of the support structure) and holding interface 216 containing the reflective particles or nanoparticles in place. In some examples, a high surface tension and interfacial tension contribute to reducing the power required to hold liquid mirror 202 in place, e.g., to hold first liquid 212, reflective layer 208, and/or second liquid 210 in place.

In some examples, ionic liquids with appropriate viscosities, thermal conductivities, and glass transition temperatures aid in maintaining liquid mirror 202 throughout its life cycle. For example, raising the temperature of the mixture of first and second liquids 212, 210 may be used to reduce liquid viscosity to accelerate liquid mirror 202 formation, followed by cooling to preserve the liquid. Once liquid mirror 202 has been formed, lowering the temperature, and hence increasing the viscosity, of liquid mirror 202 may cause liquid mirror 202 to resist flow or even immobilize first and/or second liquids 210, 212, interfaces 216, 218, and/or surface 220 of liquid mirror 202. A cooled viscous surface may aid in preserving the surface when, for example, forces needed to steer a satellite or point the LMT are applied. In Earth-based applications, a cooled viscous surface may aid in preserving the surface when the LMT is pointed in an arbitrary direction, e.g., in the presence of a gravitational force that would otherwise cause first and second liquids 212, 210 to flow.

In some examples, at least one of pump 240 or thermal controllers 228 are configured to withdraw first and second liquids 212, 210, e.g., from outer surface 214 back into reservoir 226. For example, liquid mirror 202 may be discarded, e.g., pump 240 may decrease a pressure within reservoir 226 to draw first and second liquids 212, 210 back into reservoir 226 through conduits 236. In some examples, first and second liquids 212, 210 are filtered to remove any debris, micrometeoroids, or the like, and then restored/reformed later, e.g., to repair liquid mirror 202 following impacts to interfaces 216, 218, and/or surface 220 such as from micrometeoroids or small debris strikes, or to repair and/or reform liquid mirror 202 after tilting and/or moving liquid mirror 202 via an acceleration.

In some examples, the ionic liquid materials are configured to have a reduced hygroscopic property. In some examples, the liquid materials are configured to be protected from moisture, e.g., in Earth-based application or until launched into space.

FIG. 2B is a schematic cross-sectional views of example liquid mirror 202 and support structure 206 including reservoir 226 separated e.g., by walls 248, 250, into a plurality of sub-chambers, e.g., sub-chambers 226a-226c, which each sub-chamber being fluidically coupled to auxiliary reservoir 246 via a plurality of conduits 242a-242c and pumps 240a-240c. In some examples, sub-chambers 226a-226c may be fluidically isolated from each other, and pumps 240a-240c may be configured to change, e.g., increase or decrease, and amount of fluid or pressure within sub-chambers 226a-226c independently of each other. For example, if more of first and/or second fluid 210, 212 is needed on one side of liquid mirror 202, e.g., corresponding to sub-chamber 226a, in order to change a thickness of first and/or second liquids 210, 212 at that portion of liquid mirror 202, pump 240a may be configured to increase a pressure within sub-chamber 226a in order to move first and/or second fluid 210, 212 through conduits 236a, 236b while pumps 240b and 240c may be configured to hold the pressure the same within sub-chambers 226b and 226c.

FIG. 2C is a schematic cross-sectional views of example liquid mirror 202 and support structure 206 including reservoir 226 separated e.g., by walls 248, 250, into a plurality of sub-chambers, e.g., sub-chambers 226a-226c, which each sub-chamber being fluidically coupled to auxiliary reservoir 246 via a plurality of conduits 242a-242c and valves 241a-241c, and a single pump 240. In some examples, sub-chambers 226a-226c may be fluidically isolated from each other, and pump 240, in conjunction with valves 241a-241c, may be configured to change, e.g., increase or decrease, and amount of fluid or pressure within sub-chambers 226a-226c independently of each other. For example, if more of first and/or second fluid 210, 212 is needed on one side of liquid mirror 202, e.g., corresponding to sub-chamber 226a, in order to change a thickness of first and/or second liquids 210, 212 at that portion of liquid mirror 202, pump 240 may be configured to increase a pressure within conduits 242a-242c and open valve 241a in order to move first and/or second fluid 210, 212 through conduits 236a, 236b while valves 241b and 241c may be configured to be closed to hold the pressure the same within sub-chambers 226b and 226c.

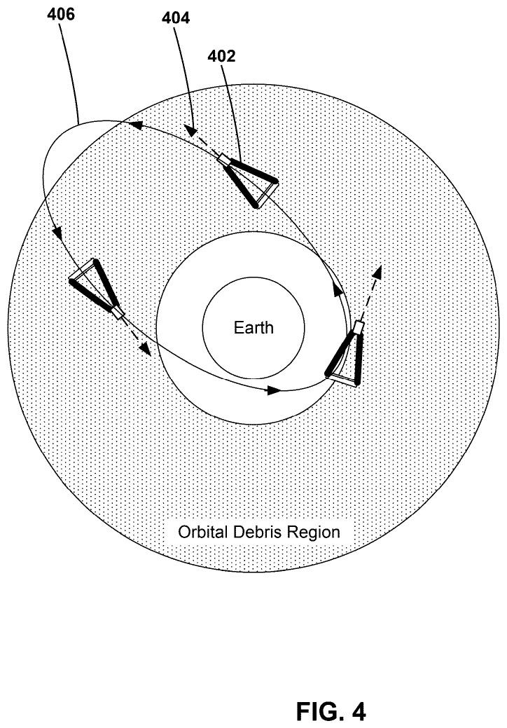

FIG. 4 is a schematic illustration of an example LMT 402 orbit 406 to observe space debris. LMT 402 may include liquid mirror 102 or liquid mirror 202 describe above. An acceleration, e.g., a thrust in a thrust direction 404, for orbit raising may be in the same direction as the orbital motion. If the spacecraft spins around thrust vector 404 and this thrust is maintained around an entire orbit, then LMT 402 field of view may scan a large arc across the sky as shown in FIG. 4, or LMT 402 may periodically point in other directions for short periods of time, e.g., to increase the field of view. Although FIG. 4 illustrates an elliptical orbit 406, other orbits may be used, e.g., a circular and/or continuously expanding orbit. In some examples, once the orbit has been raised sufficiently, LMT 402 leaves the volume of the debris cloud and may no longer be able to observe it. At this point, the process may be reversed by application of the thrust in the opposite direction of orbital motion, lowering the orbit.

In some examples, LMT 402 is configured for detailed inspection of specific spacecraft, e.g., when LMT 402 is in proximity to a target. For example, at a distance of about 200 kilometers (km) distance, details as small as about 1 centimeter (cm) may be resolvable. In some examples, LMT 402 is configured to be a 10-meter diameter diffraction limited space LMT 402 with an angular resolution of about 10 milli-arcseconds, which may be sufficient to identify the functionality of a geostationary (GEO) spacecraft from a low-earth orbit (LEO), or to perform detailed inspection from distances of a few hundred kilometers, and/or would be of significant interest for astronomical imaging.

In some examples, LMT 402 is configured for targeted observations of the Earth's surfaces. For example, LMT 402 may have an orbital geometry to maintain a pointing direction towards earth via thruster acceleration, or liquid mirror 102 liquid(s) may be cooled to increase viscosity such that LMT 402 may be pointed in a direction different than the thrust acceleration (e.g., towards Earth's surface, or any direction). Thermal management may be employed to maintain the mirror shape of liquid mirror 102, e.g., during debris observation, target observation, Earth observation, outer space observation, or the like.

In some examples, support structure 206 has a paraboloid shape (e.g., at a surface of support structure 206 at outer surface 214) and/or may provide thermal management of liquid mirror 202 during use and during temperature swings used for maneuvers or mirror regeneration as described above. In some examples, to avoid stray light from the sun or Earth, LMT 402 orbit is positioned with liquid mirror 202 primarily facing deep space. The orbit may be arranged to minimize eclipses and thus portions of the spacecraft may always be heated by sunlight to approximately 50-300 K. The spin of LMT 402 may be configured to distribute heat across liquid mirror 202. In some examples, heat pipes are used to transfer heat to outer surface 214 and first and/or second liquids 212, 210. In some examples, power is applied to heat outer surface 214. Cooling can be accomplished by turning off heat pipes, and/or LMT 402 may be cooled actively.

Referring to FIGS. 1-4, optical system 100 may include a full-scale liquid mirror 102 and/or 202 and may have a 10 meter diameter with a 0.3 meter depth of curvature in a 1 millimeter to 2 millimeters liquid layer, e.g., all of first liquid 212, reflective layer 208, and second liquid 210 having a combined nominal thickness of between about 1 millimeter to about 10 millimeters. The optical focus (e.g., the effective focal length) may be 20 meters from the primary mirror, e.g., liquid mirror 202. Auxiliary optics may provide image quality across, for example, a moderate field of view. The optics and camera of detection module 104 may be deployed on struts 108. Alignment between the optics/camera and the primary mirror 202 may be actively controlled, such as by a laser tracker system, to accommodate for thermal distortions.

Scaling a liquid mirror 202 in space may reduce some of the challenges faced on Earth when increasing liquid mirror 202 diameter, such as ripples caused by air flow over the surface or structural resonant vibrations. In space, few forces act on interfaces 216, 218, and/or surface 220, e.g., compared to on Earth. In some examples, at large scale, an LMT 402 is configured to reduce and/or compensate for time-variable effects and/or precession effects due to the orbital motion and any tilts of the rotation axis. For example, perturbations caused by the precession effects may induce a standing wave on liquid mirror 202 that is stationary in the non-rotating frame, which may have a significant impact on optical image quality unless controlled. In some examples, the amplitude of the surface displacement is greatest at a rim and/or radial edge region of liquid mirror 202 and decreases exponentially with radial distance inward from the rim and/or radial edge, and LMT 402 may be configured to reduce and/or compensate for such effects.

For example, the materials used in LMT 402 may be selected to minimize the precession effects, while balancing the impact on power and time required to prepare interfaces 216, 218, and/or surface 220. High surface tension and high viscosity liquids 212, 210 may reduce the amplitude of standing waves. The first (top) and second (base) liquids, and the material of support structure 206 may be configured for high interfacial tension to mitigate precession effects. In some examples, outer surface 214 is shaped and/or configured to provide a thin film of a predetermined static shape (e.g., a paraboloid, a predetermined shape as a function of position, or any suitable shape).

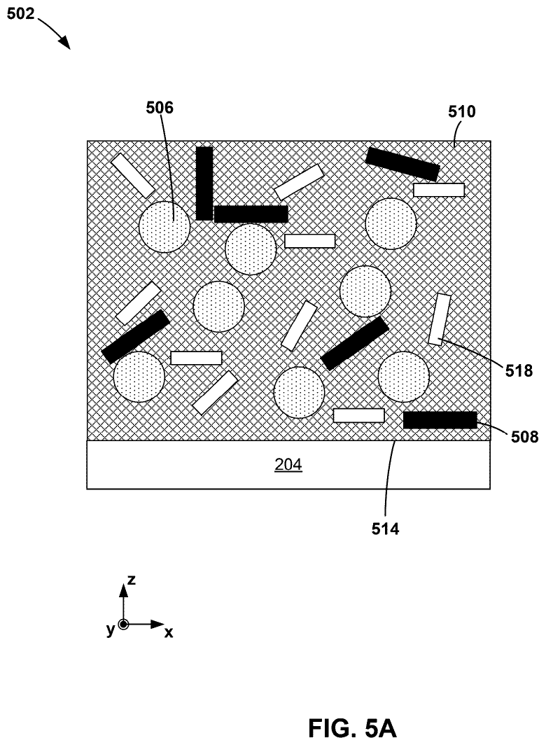

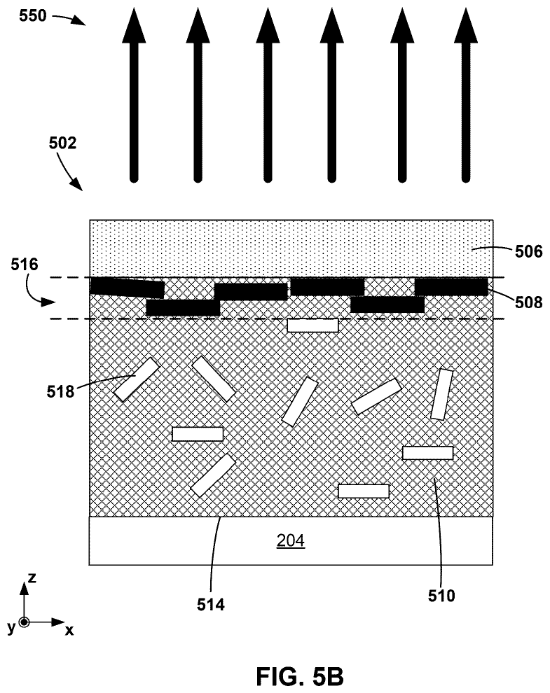

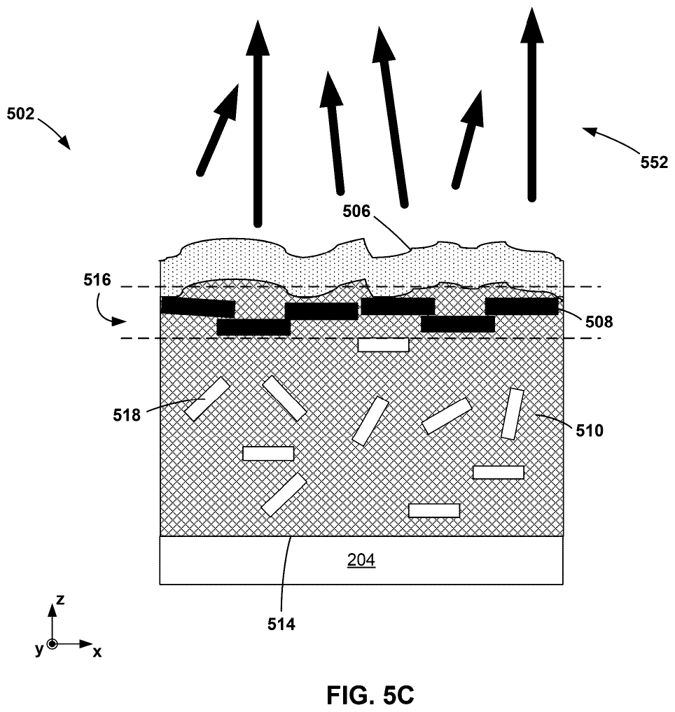

In some examples, a liquid mirror may be configured to form a focusing shape via magnetic forces, in lieu of or in addition to, capillary action. FIGS. 5A-5C illustrate liquid mirror 502 configured to form a focusing shape via magnetic forces. FIG. 5A is a schematic cross-sectional view of a portion of an example liquid mirror 502 without an applied magnetic field. FIG. 5B is a schematic cross-sectional view of a portion of liquid mirror 502 of FIG. 5A in the presence of an applied magnetic field 550 (illustrated as magnetic vectors which may results from magnetic field 550). FIG. 5C is a schematic cross-sectional view of a portion of liquid mirror 502 of FIG. 5A in the of presence a spatially varying applied magnetic field 552 (illustrated as magnetic vectors which may result from spatially varying magnetic field 552). Liquid mirror 502 may be substantially similar to liquid mirror 102 described above, except for the differences described herein.

Liquid mirror 502 includes first ionic liquid 506 and second ionic liquid 510. First ionic liquid 506 may be substantially the same as first ionic liquid 212, except that first ionic liquid 506 may be a non-polar IL (nonpolar IL 506). Second ionic liquid 510 may be substantially the same as second ionic liquid 210, except that second ionic liquid 510 may be a polar ionic liquid (polar IL 510) including a ferrofluid. In some examples, polar IL 510 includes a plurality of magnetic particles 518 suspended in polar IL 510. FIGS. 5A and 5B illustrate the formation and maintenance of a liquid mirror 502 having a focusing shape, such as a parabolic reflecting surface shape, without acceleration and/or spinning liquid mirror 102 (or without accelerating and/or spinning a structure housing liquid mirror 102, e.g., optical system 100 and/or LMT 402). As shown in FIGS. 5A and 5B, a magnetic field 550 may hold ionic liquids 506, 510 (e.g., polar IL 510 and non-polar IL 506) against mirror base 204 (which may be a structure configured to house liquid mirror 502) and spread ionic liquids 506, 510 across the dish, e.g., replacing spin and acceleration.

In the examples shown in FIGS. 5A and 5B, liquid mirror 502 also includes reflective particles 508 including a nonpolar coating and magnetic particles 518 including a polar coating. In some examples, reflective particles 508 are nanoparticles having a modified surface configured to not wet, or not be well-wetted, by polar IL 510. For example, reflective particles 508 may be configured to position and/or self-assemble at an interface 516 between polar IL 510 and nonpolar IL 506 at thermodynamic equilibrium. In some examples, magnetic particles 518 are nanoparticles having a modified surface configured to preferentially be wetted by polar IL 510.

In some examples, nonpolar IL 506 has a lower density than polar IL 510 and may “float” on top of polar IL 510, e.g., at a surface away from mirror base 204. Reflective particles 508 may have a relatively higher density such that reflective particles 506 migrate to the interface between nonpolar IL 506 and polar IL 510 rather than dispensing within nonpolar IL 506, and the volume of nonpolar 506 may be substantially small, e.g., such that reflective particles 508 do not dispense within, or are held in suspension, within nonpolar IL 506.

In the example of FIG. 5A, polar IL 510, nonpolar IL 506, reflective particles 508, and magnetic particles 518 may be homogeneously mixed, e.g., in the absence of a magnetic field 550. In the example of FIG. 5B, with the application of a magnetic field 550, e.g., via one or more magnets such as permanent magnets, electromagnets, or any suitable magnets, magnetic field 550 may induce magnetism in magnetic particles 518. For example, each particle of magnetic particles 518 may be sized such that it includes one magnetic domain. The induced magnetism may cause magnetic particles 518 to be mutually attracted to each other, and also to be attracted to the magnets, e.g., which may be underlying and/or within mirror base 204. Polar IL 510 may move along with magnetic particles 518, e.g., via wetting to magnetic particles 518, and may also move to the surface of mirror base 204 at interface 514. In some examples, polar IL 510 has an affinity for magnetic particles 518 such that magnetic particles 518 do not settle out of polar IL 510 or concentrate at the bottom of polar IL 510, e.g., near interface 514, or by the mirror surface or interface 516. For example, polar IL 510 may additionally be a ferrofluid including magnetic particles 518 configured to be suspended in the ferrofluid. As a result of the movement of polar IL 510 (e.g., with the application of magnetic field 550), nonpolar IL 506 may segregate and/or separate from polar IL 510 and form a layer floating on polar IL 510, e.g., since nonpolar IL 506 does not wet well to magnetic particles 518. For example, nonpolar IL 506 may float to the surface of polar IL 510, forming interface 516, and nonpolar IL 506 may be held to the surface of polar IL 510 by interfacial tension. Reflective particles 508 may be driven to interface 516, forming a reflective surface and/or interface 516, e.g., the mirror surface. For example, reflective particles 508 may include a nonpolar surface such that reflective particles 508 minimize their contact with polar IL 510, but the nonpolar surface of reflective particles 508 may not be nonpolar enough to dispense in nonpolar IL 506. Reflective particles 508 may then migrate, move, and/or self-assemble at interface 516 between polar IL 510 and nonpolar IL 506.

In some examples, magnetic field 550 is spatially varied to reduce and/or eliminate optical aberrations, e.g., to form an adaptive reflecting surface at interface 516. For example, mirror base 204 may house a plurality of electromagnets configured to spatially and/or temporally vary the strength of magnetic field 550 applied to liquid mirror 502 to compensate for aberrations in other optical components of an optical imaging system, e.g., a secondary mirror or lens of detection module 104, to correct for atmospheric variations and/or turbulence, and/or to correct for, or control, variations in the surface of liquid mirror 502 caused by vibrations, turbulence at a surface of liquid mirror 502, or other external forces. For example, as shown in FIG. 5C, a surface of nonpolar IL 506 may have a relatively rough and/or varying surface, e.g., before applying magnetic field 552. Magnetic field 552, which may have spatially varying magnetic field strengths, may be applies, which may correct, control, and/or smooth one or both of the outer surface of nonpolar IL 506 and interface 516, e.g., resulting in a top surface as shown in FIG. 5B and/or top surface 220 (FIG. 2).

In some examples, mirror base 204 is non-magnetic, relatively smooth, and configured to wet well to polar IL 510. In some examples, liquid mirror 502 includes walls or side walls to contain nonpolar IL 506 and polar IL 510 (not shown), which may be configured to be non-wetting. For example, such side walls may include polytetrafluoroethylene (PTFE).

In some examples, the shape of the reflecting surface of interface 516 is controlled thermally. For example, in addition to the application of a magnetic field 550, mirror base 204 may be configured to control the temperature of the surface of mirror base 204 at interface 514 as a function of position and change the properties of polar IL 510 and nonpolar IL 506 as a function of position, e.g., such as viscosity. In some example, mirror base 204 may be heated to reduce the viscosities of polar IL 510 and nonpolar IL 506, e.g., during the application of magnetic field 550 to form a shape of the reflecting surface of interface 516, and then cooled to increase the viscosity of polar IL 510 and nonpolar IL 506 to maintain the shape of the reflecting surface of interface 516, e.g., to reduce perturbations and/or changes to the shape of the reflecting surface of interface 516. In some examples, liquid mirror 502 is cooled solidify one or both of polar IL 510 and nonpolar IL 506. For example, after forming a focusing surface of interface 516, mirror base 204 may be cooled to cool polar IL 510 and nonpolar IL 506 to solidify polar IL 510 and nonpolar IL 506, e.g., each of polar IL 510 and nonpolar IL 506 may be cooled to form a non-crystalline solid (e.g., a “glass-like” solid that is substantially amorphous).

An advantage of a liquid mirror 202 is that an acceleration of liquid mirror 202, (e.g., via gravity or otherwise) or spinning of liquid mirror 202 is not required in order to form a focusing shape of the reflecting surface of interface 216 and/or reflective layer 208, and liquid mirror 202 may be reoriented to point liquid mirror 202 at objects of interest, e.g., liquid mirror 202 may be tipped, tilted, and rotated (relative to the zenith direction, illustrated as the z-direction as shown in FIG. 2) at one or more particular pitch, roll, and yaw angles of an LMT 402, or in an Earth-based application.

In some examples, reflective particles of reflective layer 208 include silver, gold, or any suitable material having a suitable reflectivity for a desired wavelength range. In some examples, liquid mirrors 102 and/or 202 include a primary mirror of a telescope. In some examples, liquid mirrors 102 and/or 202 include a mirror configured for intersatellite communication. As described above, in some examples, liquid mirrors 102 and/or 202 are regenerated if disturbed by debris. For example, liquid mirrors 102 and/or 202 may be configured to “self-heal,” e.g., by allowing the debris may settle to outer surface 114 or 214, and the reflective particles of liquid mirrors 102 and/or 202 may self-assemble to remove any perturbation caused by the debris.

In some examples, a self-assembled LMT, e.g., LMT 402, include liquid mirror 202, and may be deployed and regenerated in space and/or on Earth. For example, LMT 402 may be launched and/or deployed with first and second liquids 212, 210 within reservoir 226, to be flowed onto outer surface 214 after LMT 402 has reached its target orbit and/or target position. A parabolic reflecting surface of interface 216 may then be formed via capillary action of the first and second liquids 212, 210, that spreads the reflecting surface of interface 216 to cover outer surface 214 with a coalescence time of about 0.01 seconds, or about 0.1 seconds, or about 0.37 seconds, or about 0.5 seconds, or about 1 second, or about 10 seconds, or any suitable coalescence time, e.g., depending on a gravity and/or acceleration force, and material and/or surface properties of support structure 206, first and second liquids 212, 210, and the reflective particles. In some examples, surface tension and interfacial tension contribute to holding first and second liquids 212, 210 against outer surface 214 and holding interface 216 including the reflective particles in place. In some examples, a high surface tension and interfacial tension contribute to reducing the power required for applying thermal control via thermal controllers 128 to hold liquid mirror 202, e.g., the reflecting surface of interface 216, in place.

Although described above with reference to a plurality of liquids, e.g., first and second liquids 212, 210, or first and second ionic liquids 506, 510, liquid mirror 202 and/or 502 may comprise a single liquid and/or liquid mixture (not shown). For example, liquid mirror 202 may include only second liquid 210 and reflective particles, or liquid mirror 502 may include only second ionic liquid 510, where second liquid 210 and second ionic liquid 510 may be as described above. In some examples second liquid 210 may be a non-volatile, non-ionic liquid, such as a high molecular weight oil, and second ionic liquid 510 may not be an ionic liquid (e.g., then second liquid 510), but rather a non-volatile, non-ionic liquid, such as a high molecular weight oil. In some examples, support structure 206 may be configured to cause the single liquid (e.g., liquid 210 or liquid 510) to move within conduits 236 via capillary action as described above. In some examples, support structure 206 and the single liquid (e.g., liquid 210 or liquid 510) may be configured to cause the reflective particles to form a focusing shape, e.g., within liquid 210 or liquid 510, or at an interface, such as at interface 216 (which may be an interface with the environment, e.g., air or vacuum) or at outer surface 214 or 514.

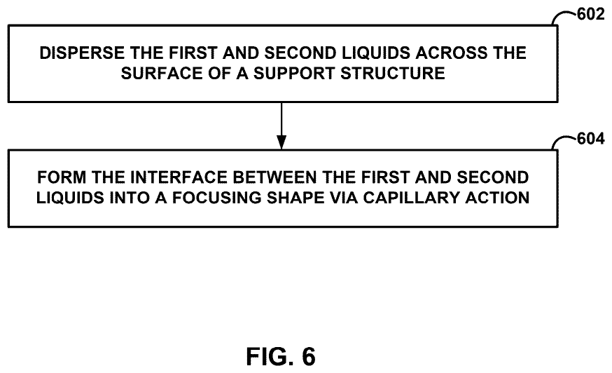

FIG. 6 is a flow diagram illustrating an example technique of forming a liquid mirror. FIG. 6 is described with reference to optical system 100 of FIG. 1, liquid mirror 102 and/or 202 of FIGS. 1 and 2, and LMT 402 of FIG. 4. However, the techniques of FIG. 6 may be utilized to make different liquid mirrors and/or additional or optical systems.

A system 100 may dispense a first liquid 212 and a second liquid 210 across outer surface 214 of support structure 206 (602). For example, support structure 206 may release the first and second liquids 212, 210 from reservoir 226 within support structure 206 via capillary action through conduits 236 to flow across outer surface 214 via capillary action to form a focusing interface 216 and/or reflective layer 208. In some examples, first and second liquids 212, 210 are thoroughly mixed, e.g., before being dispensed across outer surface 214, while being disposed across outer surface 214, or after being disposed across outer surface 214. For example, first and second liquids 212, 210 may both be housed within reservoir 226 and mixed, e.g., via induced shear. In other examples, first and second liquids 212, 210 may be stored in the same or different reservoirs and forced through a mixer that applies shear and is fluidically coupled to outer surface 214. First and second liquids 212, 210, including any reflective particles or nanoparticles, may then be dispensed across outer surface 214 via capillary action.

The system 100 may form interface 216 and/or reflective layer 208 between first and second liquids 212, 210 via capillary action (604). For example, thermal controllers 228 may heat or cool at least portions of outer surface 214 to control a temperature profile of outer surface 214 as a function of position, and/or a temperature of first and second liquids 212, 210 in contact with outer surface 214 as a function of position, to control the capillary action of first and second liquids 212, 210 across outer surface 214 to form interface 216 and/or reflective layer 208 to a predetermined shape, e.g., a focusing shape such as a paraboloidal shape (or a spherical shape or a hyperboloid shape) with optical quality, e.g., variations on the order of less than a wavelength of the light being focused. In some examples, thermal controllers 228 and/or pump 240 increase or decrease a volume of first and second liquids 212, 210 along at least a portion of the surface area of outer surface 214, e.g., controlling the flow of first and second liquids 212, 210 within conduits 236.

Select examples of the present disclosure include, but are not limited to, the following examples.

Example 1: A liquid mirror includes: a first liquid; a second liquid immiscible with the first liquid and configured to define an interface between the first liquid and the second liquid; a plurality of reflective particles configured to self-assemble at the interface between the first liquid and the second liquid; and a support structure defining an outer surface configured to support the first liquid and the second liquid, wherein the outer surface, the first liquid, and the second liquid are configured to cause the plurality of reflective particles to form a focusing shape via capillary action of the first liquid and the second liquid and interaction with the support structure.

Example 2: The liquid mirror of example 1, wherein at least one the first liquid or the second liquid includes an ionic liquid.

Example 3: The liquid mirror of example 1 or example 2, wherein the focusing shape is at least one of a paraboloidal shape, a spherical shape, or a hyperboloidal shape.

Example 4: The liquid mirror of any one of examples 1 through 3, wherein the support structure is configured to direct at least one of the first liquid or the second liquid to the outer surface of the support structure as a function of position within an area of the outer surface of the support structure.

Example 5: The liquid mirror of example 4, wherein the outer surface of the support structure is fluidically coupled to a reservoir configured to hold the first liquid and the second liquid.

Example 6: The liquid mirror of example 5, wherein the support structure defines at least one of a plurality of lumens or a plurality of pores fluidically coupling the outer surface to the reservoir.

Example 7: The liquid mirror of any one of examples 1 through 6, further including a pump configured to deploy or withdraw at least one of the first liquid or the second liquid to or from the reservoir to increase or decrease a respective volume of the first liquid or the second liquid along at least portion of the outer surface.

Example 8: The liquid mirror of any one of examples 1 through 7, further including a thermal controller configured to at least one of heat or cool a portion of the surface area of the outer surface.

Example 9: The liquid mirror of any one of examples 1 through 8, further including: a plurality of magnetic particles, wherein the support structure includes a magnet configured to induce magnetism in magnetic particles and cause the magnetic particles to be mutually attracted to each other and move within at least one of the first liquid or the second liquid and cause the first and second liquids to define the interface between the first liquid and the second liquids.

Example 10: A method of forming a liquid mirror, the method including dispensing a first liquid and a second liquid across an outer surface defined by a support structure, wherein the second liquid is immiscible with the first liquid and is configured to define an interface between the first liquid and the second liquid, wherein at least one of the first liquid or the second liquid includes a plurality of reflective particles configured to self-assemble at the interface between the first liquid and the second liquid; and forming, via capillary action, the interface into a focusing shape.

Example 11: The liquid mirror of example 10, wherein at least one of the first liquid or the second liquid includes an ionic liquid.

Example 12: The liquid mirror of example 10 or example 11, wherein the focusing shape is at least one of a paraboloidal shape, a spherical shape, or a hyperboloidal shape.

Example 13: The method of any one of examples 10 through 12, wherein forming the interface into the focusing shape includes at least one of heating or cooling a portion of the surface area of the outer surface.

Example 14: The method of any one of examples 10 through 13, wherein forming the interface into the focusing shape includes at least one of increasing or decreasing a volume of the first or second liquids along a portion of the surface area of the outer surface.

Example 15: The method of any one of examples 10 through 14, wherein dispensing the first liquid and the second liquid across the outer surface of the support structure includes causing the first liquid and the second liquid to flow from a reservoir fluidically coupled to the support structure.

Example 16: The method of example 15, wherein the support structure defines at least one of a plurality of lumens or a plurality of pores fluidically coupling the outer surface to the reservoir.

Example 17: The method of any one of examples 15 and 16, wherein the liquid mirror includes diameter of at least 5 meters and an F/# of about F/2 or less.

Example 18: A liquid mirror includes a liquid; a support structure defining an outer surface configured to support the liquid; and a plurality of reflective particles configured to self-assemble at an interface between the liquid and an external environment or between the liquid and the outer surface, wherein the outer surface and the liquid are configured to cause the plurality of reflective particles to form a focusing shape via capillary action of the liquid; and a thermal controller configured to cool a portion of the surface area of the outer surface to a temperature sufficient to immobilize the liquid to maintain the focusing shape of the interface.

Example 19: The liquid mirror of example 18, wherein the thermal controller is configured to heat a portion of the surface area of the outer surface to a temperature sufficient to mobilize the liquid to allow the liquid to flow to change the shape of the interface.

Example 20: The liquid mirror of example 18 or example 19, wherein the support structure defines at least one of a lumen or a pore fluidically coupling the outer surface to a reservoir configured to house the liquid, wherein the thermal controller is configured to increase or decrease, via heating or cooling a portion support structure, a flow of the liquid through the lumen or the pore.

Various examples have been described. These and other examples are within the scope of the following claims.

What is claimed is:

1. A liquid mirror comprising:
a first liquid;
a second liquid immiscible with the first liquid and configured to define an interface between the first liquid and the second liquid;
a plurality of reflective particles configured to self-assemble at the interface between the first liquid and the second liquid; and
a support structure defining an outer surface configured to support the first liquid and the second liquid,
wherein the outer surface, the first liquid, and the second liquid are configured to cause the plurality of reflective particles to form a focusing shape via capillary action of the first liquid and the second liquid and interaction with the support structure.

2. The liquid mirror of claim 1, wherein at least one the first liquid or the second liquid comprises an ionic liquid.

3. The liquid mirror of claim 1, wherein the focusing shape is at least one of a paraboloidal shape, a spherical shape, or a hyperboloidal shape.

4. The liquid mirror of claim 1, wherein the support structure is configured to direct at least one of the first liquid or the second liquid to the outer surface of the support structure as a function of position within an area of the outer surface of the support structure.

5. The liquid mirror of claim 4, wherein the outer surface of the support structure is fluidically coupled to a reservoir configured to hold the first liquid and the second liquid.

6. The liquid mirror of claim 5, wherein the support structure defines at least one of a plurality of lumens or a plurality of pores fluidically coupling the outer surface to the reservoir.

7. The liquid mirror of claim 1, further comprising a pump configured to deploy or withdraw at least one of the first liquid or the second liquid to or from the reservoir to increase or decrease a respective volume of the first liquid or the second liquid along at least portion of the outer surface.

8. The liquid mirror of claim 1, further comprising a thermal controller configured to at least one of heat or cool a portion of the surface area of the outer surface.

9. The liquid mirror of claim 1, further comprising:
a plurality of magnetic particles, wherein the support structure includes a magnet configured to induce magnetism in magnetic particles and cause the magnetic particles to be mutually attracted to each other and move within at least one of the first liquid or the second liquid and cause the first and second liquids to define the interface between the first liquid and the second liquids.

10. A method of forming a liquid mirror, the method comprising:
dispensing a first liquid and a second liquid across an outer surface defined by a support structure, wherein the second liquid is immiscible with the first liquid and is configured to define an interface between the first liquid and the second liquid, wherein at least one of the first liquid or the second liquid comprises a plurality of reflective particles configured to self-assemble at the interface between the first liquid and the second liquid; and
forming, via capillary action, the interface into a focusing shape.

11. The liquid mirror of claim 10, wherein at least one of the first liquid or the second liquid comprises an ionic liquid.

12. The liquid mirror of claim 10, wherein the focusing shape is at least one of a paraboloidal shape, a spherical shape, or a hyperboloidal shape.

13. The method of claim 10, wherein forming the interface into the focusing shape comprises at least one of heating or cooling a portion of the surface area of the outer surface.

14. The method of claim 10, wherein forming the interface into the focusing shape comprises at least one of increasing or decreasing a volume of the first or second liquids along a portion of the surface area of the outer surface.

15. The method of claim 10, wherein dispensing the first liquid and the second liquid across the outer surface of the support structure comprises causing the first liquid and the second liquid to flow from a reservoir fluidically coupled to the support structure.

16. The method of claim 15, wherein the support structure defines at least one of a plurality of lumens or a plurality of pores fluidically coupling the outer surface to the reservoir.

17. The method of claim 15, wherein the liquid mirror comprises diameter of at least 5 meters and an F/# of about F/2 or less.

18. A liquid mirror comprising:
a liquid;
a support structure defining an outer surface configured to support the liquid; and
a plurality of reflective particles configured to self-assemble at an interface between the liquid and an external environment or between the liquid and the outer surface,
wherein the outer surface and the liquid are configured to cause the plurality of reflective particles to form a focusing shape via capillary action of the liquid; and
a thermal controller configured to cool a portion of the surface area of the outer surface to a temperature sufficient to immobilize the liquid to maintain the focusing shape of the interface.

19. The liquid mirror of claim 18, wherein the thermal controller is configured to heat a portion of the surface area of the outer surface to a temperature sufficient to mobilize the liquid to allow the liquid to flow to change the shape of the interface.

20. The liquid mirror of claim 18, wherein the support structure defines at least one of a lumen or a pore fluidically coupling the outer surface to a reservoir configured to house the liquid,
wherein the thermal controller is configured to increase or decrease, via heating or cooling a portion support structure, a flow of the liquid through the lumen or the pore.
